(19) United States
(12) Patent Application Publication
(10) Pub. No.: US 2006/0041871 A1
(43) Pub. Date: Feb. 23, 2006

(54) Resource description framework transcoder repository and methods for exposing data assets

(76) Inventors: Richard Friedman, Cherry Hill, NJ (US); Joseph John Snyder, Shamong, NJ (US); Jason A. Kinner, Shamong, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/114,527

(22) Filed: Apr. 26, 2005

Related U.S. Application Data
(60) Provisional application No. 60/565,704, filed on Apr. 27, 2004.

(51) Int. Cl. G06F 9/45

(52) U.S. Cl. 717/136

(57) ABSTRACT

A resource description framework transcoder repository includes an interface, a resource manager and at least one resource description framework transcoder. The interface receives indicia of a first metadata scheme used to receive digital assets. The resource manager identifies digital assets stored under the same and different metadata schemes. When the first metadata scheme does not match the identified metadata scheme, the resource manager accesses an appropriately configured resource description framework transcoder. The resource description framework transcoder translates metadata associated with digital assets from the identified metadata scheme to the first metadata scheme thus exposing the digital assets.

### CROSS-REFERENCE TO RELATED APPLICATION

This application claims priority to copending U.S. provisional application entitled, “RESOURCE DESCRIPTION FRAMEWORK TRANSCODER REPOSITORY AND METHODS FOR EXPOSING DATA ASSETS,” having Ser. No. 60/565,704, filed Apr. 27, 2004, which is entirely incorporated herein by reference.

### BACKGROUND

The ubiquitous nature of computing devices and networks has led to the proliferation of digital assets on computers and within storage devices. These digital assets include multiple data types associated with multiple product types, such as video, audio, dynamic documents, slide presentations, among others. Many of these digital assets are difficult to characterize using the paradigm of a relational database. A significant factor that leads to the difficulty in quantifying these content rich media assets is that the items are generally human readable rather than machine readable as they often contain little or no data that can be consistently indexed and searched.

The Resource Description Framework (RDF) developed by the World-Wide Web Consortium (W3C) provides a foundation for metadata interoperability across different resource description communities. Metadata is information about data, such as content-rich media assets. One of the major obstacles facing the resource description community is the multiplicity of incompatible standards for metadata syntax and schema definition languages. The use of incompatible standards has lead to the lack of and low deployment of cross-discipline applications and services for resource description communities. The RDF provides a solution to these problems via a syntax specification (W3C, 1999a) and a schema specification (W3C, 1998a).

The RDF is based on technologies commonly used across the Internet and, as a result, is lightweight and highly deployable. The RDF provides interoperability between applications that exchange metadata and is targeted for many application areas including; resource description, site maps, content rating, electronic commerce, collaborative services, and privacy preferences, among others. The RDF is the result of members of these communities reaching consensus on their syntactical needs and deployment efforts.

The objective of the RDF is to support the interoperability of metadata. The RDF provides a common description for accessing metadata associated with network-coupled digital assets and other resources that is, any object with a Uniform Resource Identifier (URI) as its address, can be made available in a machine understandable form. This enables the semantics of objects to be expressible and exploitable across multiple applications. Once highly deployed, the RDF will enable services to develop processing rules for automated decision-making about Internet accessible resources.

### SUMMARY

A resource description framework (RDF) transcoder repository and methods for exposing data assets are invented and disclosed. The RDF repository comprises an interface, a resource manager, and at least one resource description framework transcoder. The interface receives indicia of a first metadata scheme. The resource manager identifies the metadata scheme used to index digital assets. When the first metadata scheme is different from the metadata scheme used to index digital assets, the resource manager accesses the RDF transcoder. The RDF transcoder is configured to translate the metadata scheme used to index the digital assets such that the transcoded data is compatible with the first metadata scheme.

### BRIEF DESCRIPTION OF THE DRAWINGS

The RDF transcoder repository and methods for exposing data assets in a data store are illustrated by way of example and not limited by the implementations depicted in the following drawings. The components in the drawings are not necessarily to scale relative to each other; emphasis instead is placed upon clearly illustrating the principles of the RDF transcoder repository and the methods for exposing data assets in a data store. Moreover, in the drawings, like reference numerals designate corresponding parts throughout the several views.

FIG. 1 is a schematic diagram illustrating an embodiment of a content management system that includes a RDF transcoder repository.

FIG. 2 is a schematic diagram further illustrating an embodiment of the repository layer of FIG. 1.

FIG. 3 is a functional block diagram illustrating client interaction with the metadata and asset stores of FIG. 2 via the repository layer of FIG. 1.

FIG. 4 is a schematic diagram illustrating an embodiment of a metadata element set.

FIG. 5 is a schematic diagram illustrating sample-qualified elements of the date element of the metadata element set of FIG. 4.

FIG. 6 is a functional block diagram illustrating an embodiment of the transcoder repository of FIG. 3.

FIG. 7 is a flow diagram illustrating an embodiment of a method for transforming metadata in a datastore that can be implemented using the RDF transcoder repository of FIG. 3.

FIG. 8 is a flow diagram illustrating an embodiment of a method for processing metadata transformation requests that can be implemented using the RDF transcoder repository of FIG. 3.

### DETAILED DESCRIPTION

A RDF transcoder repository and methods for exposing data assets in a data store are invented and disclosed. The methods expose human-readable digital assets stored and indexed under a metadata scheme to applications that prefer to interface with digital assets indexed and stored under a first metadata scheme. Human readable digital assets include data content rich materials such as video, audio, and audio-visual files, dynamic documents, slide presentations, among others. These data content rich materials include information that is not readily extractable by machines.

The RDF transcoder repository includes an interface, a resource manager and at least one RDF transcoder. The interface receives indicia of a first metadata scheme used to receive digital assets. The resource manager identifies digital assets stored under the same and different metadata schemes. When the first metadata scheme does not match the identified metadata scheme, the resource manager accesses an appropriately configured RDF transcoder. The RDF transcoder translates metadata associated with digital assets from a first metadata scheme to a second metadata scheme. The translated metadata can then be used by client applications to locate and use data assets from accessible data stores. Consequently, the RDF transcoder repository can be used to expose data assets to client applications.

Content Management System

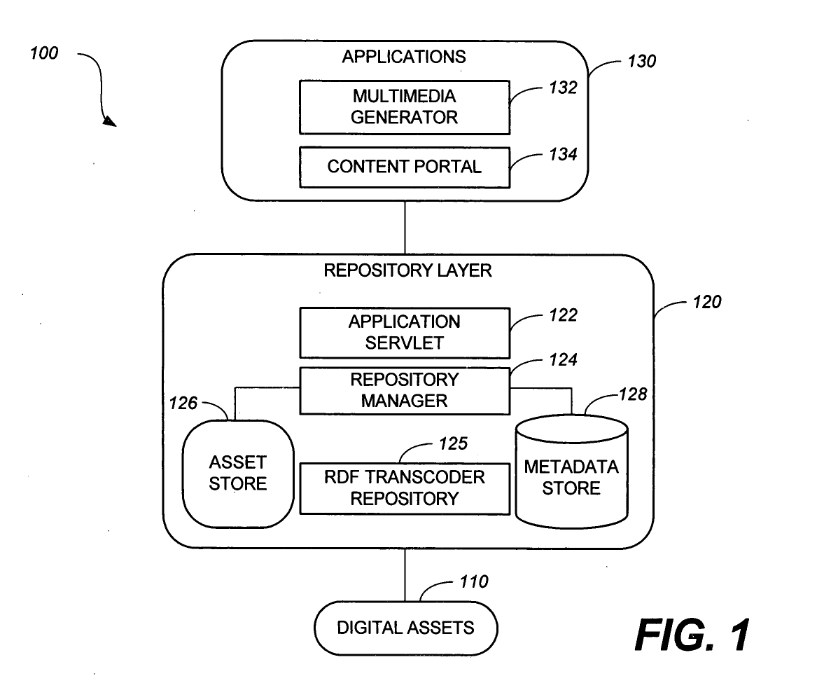

The digital data asset and constructs for its storage and access are at the heart of a content management system. The content management system illustrated in FIG. 1 is an example of a system that includes client applications that provide, store, manipulate, and accesses digital assets. In this regard, content management system 100 comprises a repository layer 120 that exposes digital assets 110 to client applications 130. In the illustrated example, client applications include multimedia generator 132 and content portal 134. However, content management system 100 can include any arrangement of additional client applications (not shown for simplicity of illustration and description).

The repository layer 120 includes an application servlet 122 and a repository manager 124 that integrate digital assets 110 via asset store 126 and metadata store 128. Servlets are a popular component used in building web applications. Servlet technology provides web service developers with a simple consistent mechanism for extending the functionality of existing business systems accessible to end users via a web server. Servlets provide a component-based platform independent method for building web applications without the performance limitations inherent in the common gateway interface (CGI—a web scripting facility.)

Providing an abstraction to the digital assets 100 is the key to developing rich media-based applications and services. Defining the repository layer 120 has the same importance as defining a common language and application programming interface (API) for accessing traditional relational database systems. The repository layer 120 is comprised of asset store 126, metadata about the asset in metadata storage 128, and the structure to store this information as provided by repository manager 124. The repository layer 120 provides “edit” features such as insert, update, delete and query. The repository layer 120 further includes a RDF transcoder repository 125. The RDF transcoder repository 125 stores a plurality of transcoders configured to convert and/or otherwise translate metadata stored under a first metadata schema to a second metadata schema. Each of the plurality of internal transcoders is configured to perform a unique metadata translation, thus exposing the underlying assets (e.g., assets in asset store 126) described by metadata across applications that use a particular metadata scheme. Where and how to store human readable digital assets, metadata, and the associations between them, is a complex problem. Different client applications 130 can have vastly different requirements for asset storage. The content management system 100 provides an abstract storage mechanism that supports heterogeneous storage for digital assets 110, related metadata, and data structures.

Web Distributed Authoring and Versioning (WebDAV) is a specification that addresses the storage of digital assets 110, metadata about the assets, and data structures for their storage. WebDAV is currently in use in network storage solutions and web servers. In addition, WebDAV is supported in many authoring tools. WebDAV is divided into three separate specifications, each of which address particular storage operations: WebDAV, DASL (Distributed Authoring and Versioning Searching and Locating), and Delta-V (Versioning).

The storage abstraction architecture uses many components, which create both the abstractions for the storage system, as well as, a usable storage infrastructure upon which systems are created. The content management system 100 includes client-side components and server-side components, other servers, and net applications coupled via a network infrastructure. A .net application is software stored on a network that interacts with system software on a computing device to assist a user of the computing device. A .net application removes the boundary between applications and the Internet. Instead of interacting with an application or a single Web site, a .net application connects the user to an array of computers and services that exchange and combine objects and data.

Client-side components are operable on workstations, laptop computers, and a host of other computing devices. Client-side components include an HTTP client interface for establishing a network communication session via the network infrastructure, as well as a host of content management system (CMS) interface modules. Server-side components are operable on web servers. Server-side components can include open source components. These components provide an abstraction layer that allows selection of the type of mechanism to use for data stores including content and metadata stores. The abstraction layer enables in-memory stores, database stores, XML stores, among others.

Metadata processing is an important aspect of applications such as content portal 134 that attempt to expose human-readable digital assets 110 to clients via computing devices in a way in which the clients can meaningfully exploit the assets.

Metadata

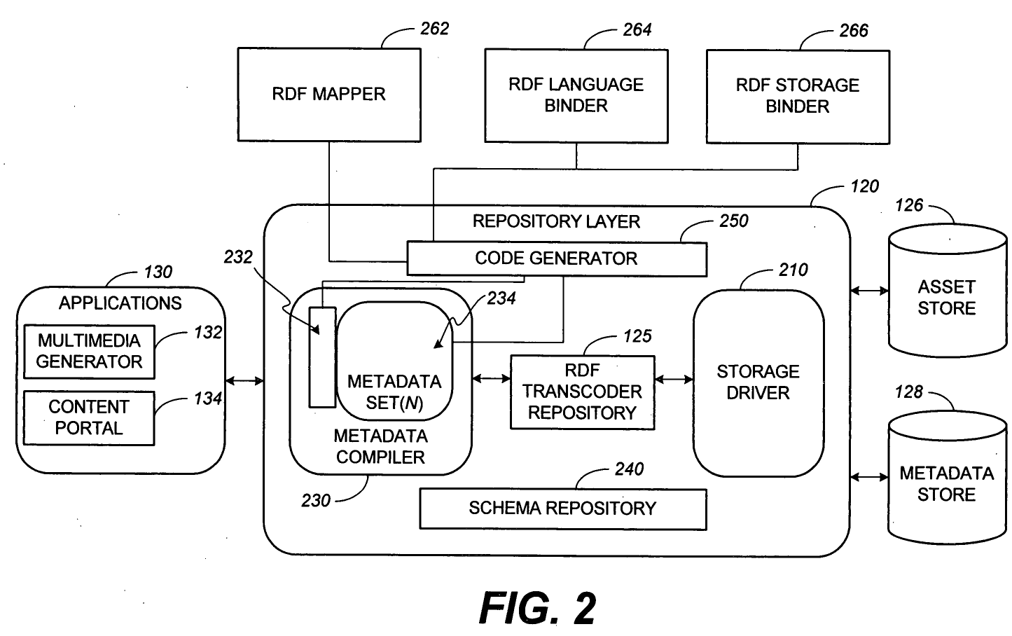

Metadata processing is an integral part of any rich-media application. Typically, rich-media assets do not contain data that is easily indexed, searched, or used for decision-making processes in applications. Asset metadata is similar to traditional business-processing data, but it is different in that it is primarily human-readable rather than machine-readable. The structure of data is not fixed as in business-oriented systems, and the set of data to be tracked is dynamic. The metadata-storage framework illustrated in FIG. 2 provides a mechanism by which metadata sets can be deployed like application components while still providing the flexibility required by rich-media applications.

The metadata store 128 illustrated in FIG. 2 is based on work in the digital library community. In a preferred embodiment, metadata store 128 is structured under an implementation of the Warwick Framework architecture. The Warwick Framework architecture is based on container architecture, familiar in J2EE architectures. Metadata sets 234 are deployed to this container and are made available through both common and specific APIs. Common APIs allow for dynamic discovery of metadata while the specific APIs allow applications to be written against specific metadata sets. FIG. 2 shows the overall architecture of the repository layer 120. A deployable component within the repository layer 120 is a metadata set 234.

The deployed metadata set 234 consists of a description of the relationships between the properties in the set, the native type binding of those properties and the binding to the storage layer. The relationships between the properties in a metadata set 234 can be described in a general way so that the description can be deployed to different containers that may be implemented on different data platforms. The native type binding description as defined by RDF mapper 262, RDF language binder 264, and RDF storage binder 266 is specific to a programming language and is used to generate code (e.g., in code generator 250) that implements the binding. Storage binder 266 allows properties in multiple metadata sets to map to a single value in storage (the canonical property). Part of the storage binding defines the transcoding required in the RDF transcoder repository 125 to transform a property value encoded in storage driver 210 into the proper encoding for a specific metadata set 234.

A client application 130 such as content portal 134 makes calls on the metadata store 128 via metadata set interface 232 to the object that holds the values of the properties, and on any metadata sets 234 integrated in the metadata framework. A configured storage driver manages the persistence of property values. FIG. 2 further illustrates the flow of data between the components of the metadata store 128. The low-level storage driver 210 provides native type binding through a generic, Java database connectivity (JDBC)-like API. The higher-level metadata set API delivers property values not only in the proper native type but also in the proper encoding for that metadata set. An application can choose to use such an API in order to take advantage of the metadata transcoding facilities built into the metadata store 128 and to avoid having metadata mappings for each of the components in an application.

The metadata store 128 is discovered at runtime via the Java naming and directory interface (JNDI). The JNDI name of the metadata store 128 is of the form metadata:configurationURL. The configurationURL can be in many different forms. The most basic is an absolute file URL, such as file:/c:/hpmw/hpas/config/metadata-container.xml, which can be used to locate the metadata store 128. A relative URL, such as /metadata-container.xml, can be used when the configuration file is in a Web application (WAR) file, accessible from the document root, or when the configuration file is in the class path. The JNDI provider will return at most one copy of the metadata store 128 object, configured as specified by the configuration file.

Configuring the metadata store 128 consists of configuring the schema repository 240 (e.g., a Jena model), features of the metadata set compiler 230, a storage driver 210, and the deployed metadata sets 234. The configuration starts with the XML element metadata-container. The XML element metadata-container contains a storage-driver 210, a schema-repository 240, a metadata-compiler 230, as well as one or more metadata-set elements 234. The schema-repository element 240 has a single child, class-name, that indicates a class that implements the Jena Model interface, allowing persistent or transient models to be used for the schema repository 240.

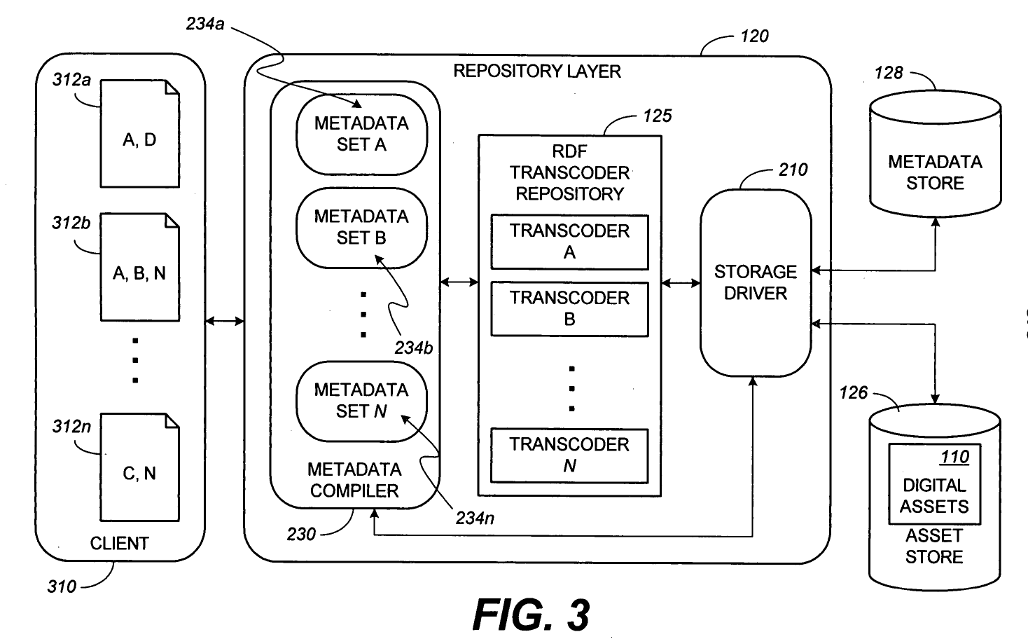

FIG. 3 is a functional block diagram illustrating client interaction with the metadata and asset stores of FIG. 2. As shown in FIG. 3, repository layer 120 serves as an interface between previously indexed and stored digital assets 110 in asset store 126 as well as metadata stored in metadata store 128 and a client application 310. The client application 310 forwards information including one or more first metadata set identifiers to repository layer 120. As indicated in FIG. 3, client application identifier 312a lists first metadata sets A and D; client application identifier 312b lists first metadata sets A, B, and N; and client application identifier 312n lists first metadata sets C and N.

Metadata compiler 230 receives the client application identifier 312 and verifies that the various first metadata sets are supported by the metadata compiler 230. When it is the case that a particular first metadata set is not supported, the metadata compiler 230 may be configured to appropriately notify client application 310. When the first metadata sets 234a, 234b, . . . , 234n are supported by the metadata compiler 230 the metadata compiler 230 accesses metadata store 128 to determine if digital assets have been indexed and stored using the first metadata sets communicated by client application 310. When it is determined the digital assets of the desired type have been indexed and stored using the first metadata sets, the RDF transcoder repository 125 can be bypassed. Otherwise, when it is determined that digital assets of the desired type have been indexed and stored using metadata sets other than the client application first metadata sets, the RDF transcoder repository 125 is accessed to determine if an appropriate transcoder is available. When an appropriate transcoder is available, the transcoder is used to translate metadata values from the metadata used to store the digital assets 110 to the client application first metadata sets.

As further illustrated in FIG. 3, storage driver 210 interfaces with both metadata store 128 and asset store 126 to store and retrieve metadata values and underlying digital assets 110 identified by the metadata. Data storage and retrieval as well as metadata storage and retrieval can be accomplished in any of a number of methods as understood by those skilled in the art.

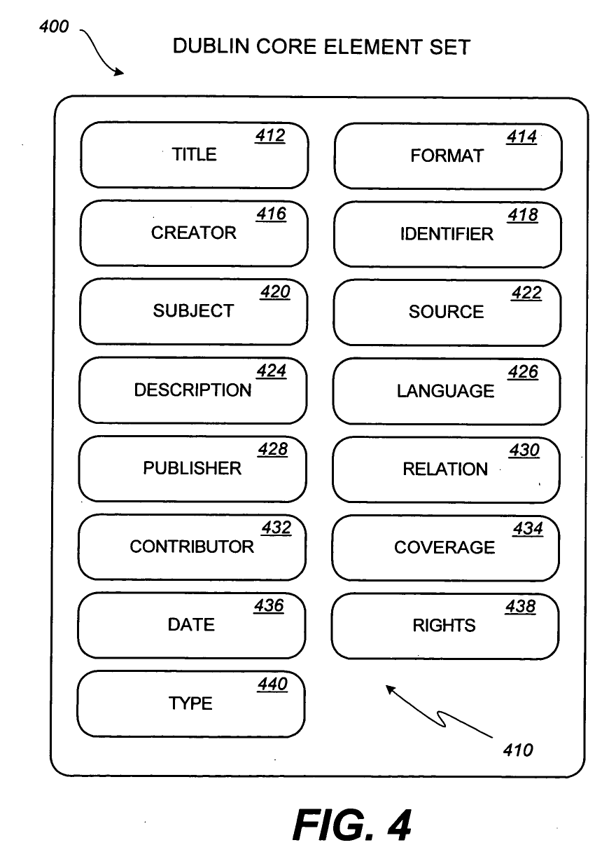

FIG. 4 is a schematic diagram illustrating an embodiment of a metadata element set 400. Specifically, FIG. 4 is a representation of the Dublin Core Element Set. The Dublin Core Element Set is a metadata element set that includes a plurality of high-level data descriptors 410. As illustrated in the schematic diagram, the Dublin Core Element Set includes the following high-level data descriptors 410: title 412, format 414, creator 416 identifier 418, subject 420, source 422, description 424, language 426, publisher 428, relation 430, contributor 432, coverage 434, date 436, rights 438, and type 440. Definitions for each of the plurality of high-level data descriptors 410 can be found in the Dublin Core Element Set, Version 1.0: Reference Description, Weibel, S.; Kunze, J.; Lagoze, C.; Wolf, M. 1998. Dublin Core Metadata for Resource Discovery. IETF #2413. The Internet Society, September 1998.

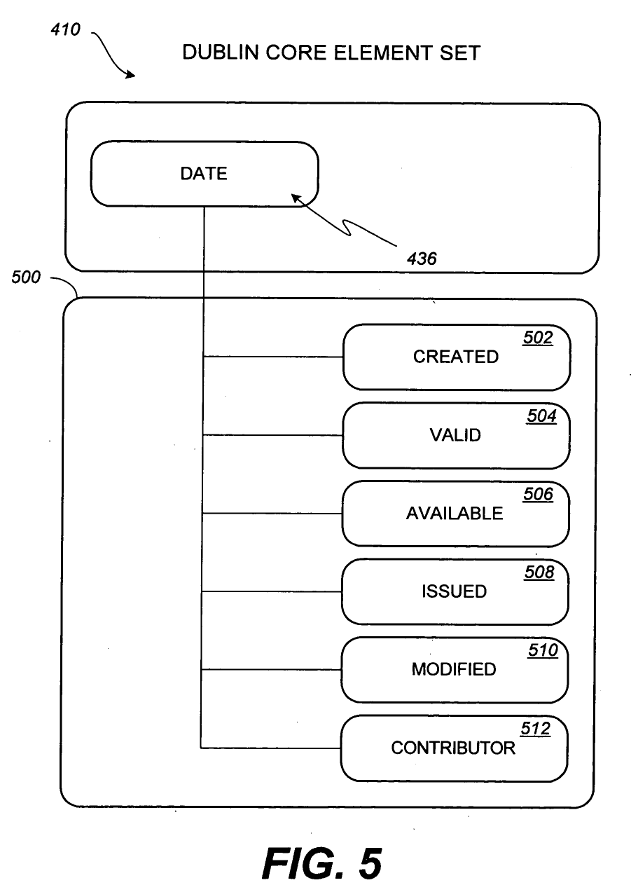

FIG. 5 is a schematic diagram illustrating sample-qualified elements 500 of the date 436 high-level data descriptor of FIG. 4. As illustrated in FIG. 5, the date 436 high-level data descriptor is further described by qualified elements created 502, valid 504, available 506, issued 508, modified 510, and contributor 512. Each of the other high-level data descriptors, namely the title 412, format 414, creator 416 identifier 418, subject 420, source 422, description 424, language 426, publisher 428, relation 430, contributor 432, coverage 434, rights 438, and type 440, will have their own corresponding set of qualified elements. Definitions for each of the qualified elements associated the high-level data descriptors 410 can also be found in the Dublin Core Element Set, Version 1.0: Reference Description.

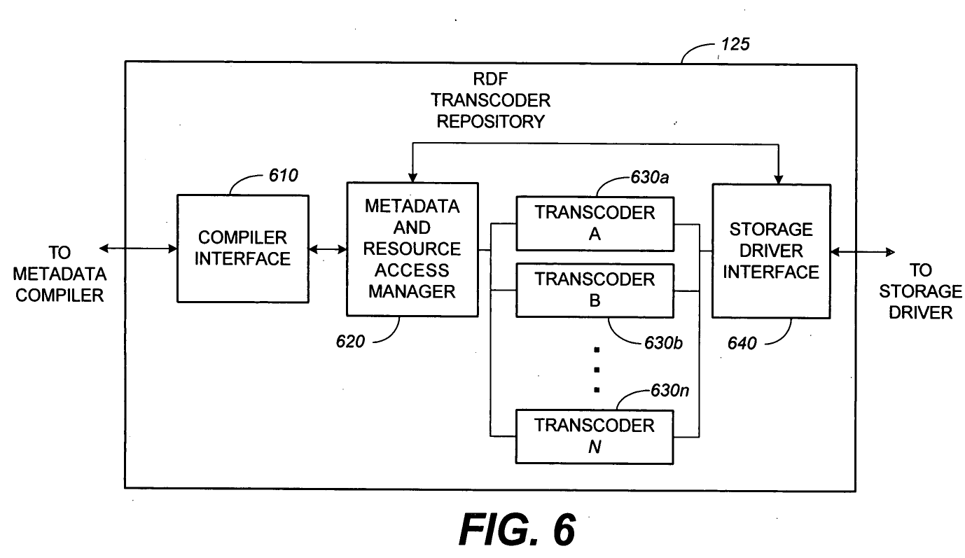

FIG. 6 is a functional block diagram illustrating an embodiment of the transcoder repository 125 of FIG. 3. The transcoder repository 125 includes a compiler interface 610, a metadata and resource access manager 620, a plurality of transcoders 630 and a storage driver interface 640. The compiler interface 610 is configured to communicate with the metadata compiler 230 (FIG. 2) and the metadata and resource access manager 620. The compiler interface 610 receives requests for metadata and particular digital assets stored in a metadata store and/or a resource data store. The compiler interface 610 returns metadata values and/or digital assets located by the metadata and resource access manager 620.

The metadata and resource access manager 620 determines if a metadata transcoder is required to process a particular metadata request forwarded from a client application. When the first metadata set does not match the metadata set that was used to store the underlying digital asset, the metadata and resource access manager 620 selects an appropriately configured transcoder 630 from the set of transcoders 630a, 630b, . . . , 630n in the RDF transcoder repository 125. A selected transcoder 630 translates the metadata values accordingly and forwards the translated metadata values to the storage driver interface 640. The storage driver interface 640 receives requests for metadata and particular digital assets stored in a metadata store and/or a resource data store from the metadata and resource access manager 610. Alternatively, the storage driver interface 640 receives translated metadata values from a select transcoder 630. The storage driver interface 640 then buffers the metadata values or data resource requests such that they are understood by the storage driver 230 (FIG. 2). The storage driver interface 640 then returns retrieved data resources (i.e., digital assets) to the metadata and resource access manager 620, which in turn, forwards the retrieved data via the compiler interface 610 and the metadata compiler 230 (FIG. 2) to client applications 130 (FIG. 2). Because the RDF transcoder repository 125 is configured with a plurality of transcoders 630 that can be dynamically accessed by client applications 130, a computing device can access any of the appropriate transcoders 630 without the need to recompile.

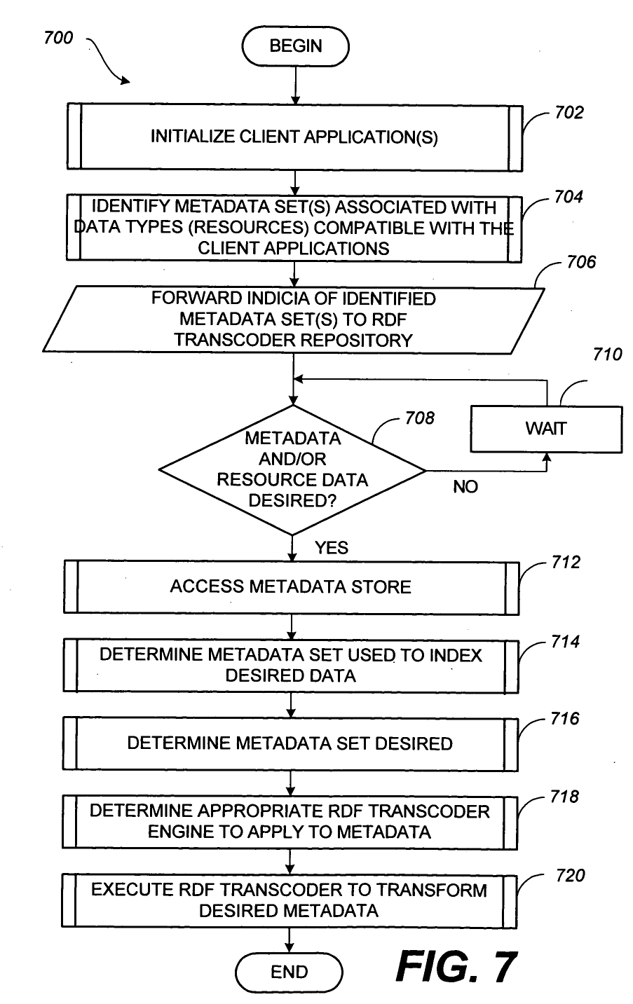

FIG. 7 is a flow diagram illustrating an embodiment of a method 700 for transforming metadata in a data store that can be implemented by a computing device using the RDF transcoder repository 125 of FIG. 4. The computing device initializes client application software in block 702. Next, as shown in block 704, the computing device identifies metadata sets associated with data types compatible with the client applications. Thereafter, as shown in block 706, the computing device forwards indicia of the identified metadata sets to the RDF transcoder repository.

When it determined that a metadata search is desired (i.e., resource data is desired) as indicated by the flow control arrow labeled, “Yes” exiting decision block 708, the computing device accesses the metadata storage as shown in block 712. Otherwise, as indicated by the flow control arrow labeled, “No” exiting decision block 708, the computing device repeats the query of decision block 708 after waiting for an amount of time as shown in block 710.

After the metadata store has been accessed, the computing device determines the metadata set used to index desired data resources as indicated in block 714. In block 716, the computing device determines a metadata set that a client application is configured to use when communicating metadata. Next, as illustrated in block 718, the computing device then determines an appropriate RDF transcoder engine to use to convert the metadata from the metadata description used to store the underlying data resources to the metadata set. Having determined the appropriate RDF transcoder to make the conversion, the computing device executes the RDF transcoder as indicated in block 720.

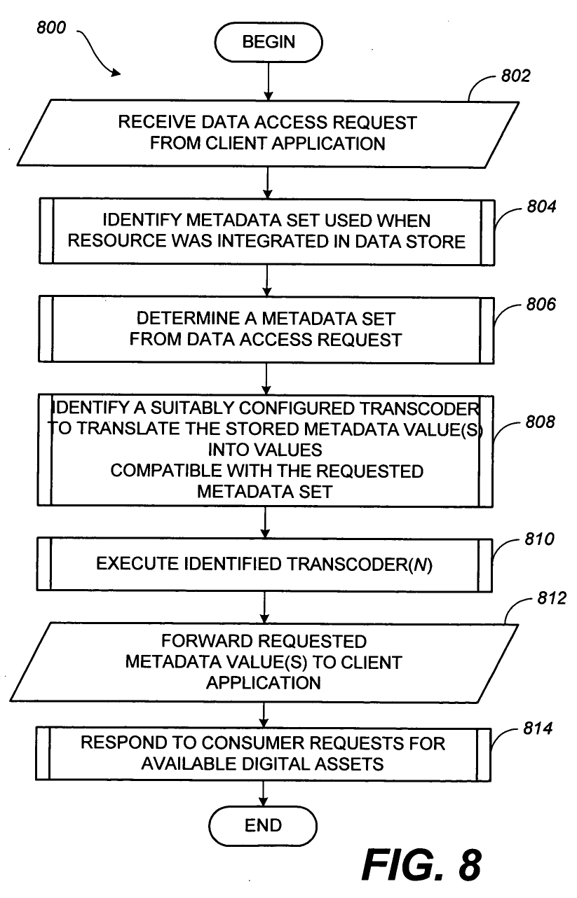

FIG. 8 is a flow diagram illustrating an embodiment of a method 800 for processing metadata transformation requests that can be implemented by a computing device having access to the RDF transcoder repository of FIG. 3. The computing device receives a data access request from a client application as indicated in block 802. In response to the data access request, the computing device identifies the metadata set used when the underlying data resource was integrated in the data store as illustrated in block 804. The computing device then identifies a metadata set from the data access request in block 806.

Next, in block 808, the computing device identifies a suitably configured transcoder to translate the stored metadata values into values compatible with the metadata set. Thereafter, as shown in block 810, the computing device executes the identified transcoder, forwards the requested metadata to the client application (as shown in block 812), and responds to consumer requests for available digital assets (as indicated in block 814).

Any process descriptions or blocks in the flow diagrams of FIGS. 7 and 8 should be understood to represent modules, segments, or portions of code which include one or more executable instructions for implementing specific logical functions or steps in the respective process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

In an embodiment, the RDF transcoder 125 is one or more source programs, executable programs (object code), scripts, or other collections each comprising a set of executable instructions to be performed. It should be understood that the compiler interface 610, the metadata and resource access manager 620, the transcoders 630, and the storage driver interface 640 can be embodied in any computer-readable medium for use by, or in connection with, an instruction-execution system, apparatus, or device, such as a computer-based system, processor-containing system, or other system that can fetch the instructions from the instruction-execution system, apparatus, or device, and execute the instructions.

In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed. The program can be electronically captured, via for instance optical scanning of the paper or other medium, then compiled, interpreted or otherwise processed in a suitable manner if necessary, and then stored in a computer memory.

Various portions of the RDF transcoder repository 125 can be implemented in hardware, software, firmware, or combinations thereof. In separate embodiments, the compiler interface 610, the metadata and resource access manager 620, the transcoders 630, and the storage driver interface 640 are implemented using a combination of hardware and software or firmware that is stored in memory and executed by a suitable instruction-execution system. If implemented solely in hardware, as in alternative embodiments, the compiler interface 610, the metadata and resource access manager 620, the transcoders 630, and the storage driver interface 740 can be separately implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In preferred embodiments, the functions of the compiler interface 610, the metadata and resource access manager 620, the transcoders 630, and the storage driver interface 640 are implemented in a combination of software and data executed and stored under the control of a computing device. It should be noted, however, that neither the compiler interface 610, the metadata and resource access manager 620, the transcoders 630, and the storage driver interface 640 are dependent upon the nature of the underlying computing device and/or upon an operating system in order to accomplish their respective designated functions.

It should be emphasized that the above-described embodiments of the RDF transcoder repository 125, the method 700 for transforming metadata in a data store, and the method 800 for processing metadata transformation requests, particularly, any “preferred” embodiments, are merely possible examples of implementations, set forth to enable a clear understanding of the principles included in the RDF transcoder repository 125 and the methods. Variations and modifications may be made to the above-described embodiment(s) of the invention without departing substantially from the principles described herein. All such modifications and variations are included within the scope of this disclosure and protected by the following claims.

We claim:

1. A resource description framework transcoder repository, comprising:
a first interface configured to receive indicia of a first metadata scheme; and
a resource manager coupled to the first interface and configured to identify a metadata scheme used to index digital assets, wherein when the first metadata scheme is different from the metadata scheme used to index digital assets, said resource manager accesses a resource description framework transcoder configured to translate the metadata scheme used to index the digital assets such that the transcoded data is compatible with the first metadata scheme.

2. The repository of claim 1, wherein the first interface receives indicia of the first metadata scheme from a client application.

3. The repository of claim 2, wherein the client application identifies at least one metadata set.

4. The repository of claim 1, further comprising:
a second interface coupled between the resource description framework transcoder and a storage driver.

5. The repository of claim 4, wherein the resource description framework transcoder enables a client application configured to use an application metadata scheme to locate a digital asset stored under a metadata scheme different from the application metadata scheme.

6. The repository of claim 5, wherein the digital asset comprises a human-readable asset.

7. The respository of claim 6, wherein the human-readable asset comprises an asset selected from the group consisting of video information, audio information, audio-visual information, dynamic documents, and slide presentations.

8. A computer-readable medium having stored thereon an executable instruction set, the instruction set, when executed by a processor, directs the processor to perform a method, comprising:
receiving a request to access a digital asset under a first metadata scheme;
identifying digital assets indexed and stored under a different metadata scheme; and
accessing a resource description framework transcoder configured to translate metadata from the different metadata scheme to a format compatible with the first metadata scheme.

9. The computer-readable medium of claim 8, wherein receiving a request further comprises information identifying a human-readable digital asset.

10. The computer-readable medium of claim 9, wherein the human-readable digital asset comprises an asset selected from the group consisting of video information, audio information, audio-visual information, dynamic documents, and slide presentations.

11. A resource description framework transcoder repository, comprising:
means for accepting a request identifying a first metadata scheme for locating digital assets;
means for identifying the metadata scheme used to index digital assets; and
means for selecting a resource description framework transcoder responsive to the first metadata scheme and the metadata scheme used to index digital assets.

12. The resource description framework transcoder repository of claim 11, further comprising:
means for executing the resource description framework transcoder.

13. The resource description framework transcoder repository of claim 11, wherein digital assets comprise human-readable digital assets.

14. The resource description framework transcoder repository of claim 13, wherein the human-readable digital assets comprise assets selected from the group consisting of video information, audio information, audio-visual information, dynamic documents, and slide presentations.

15. A method for exposing data resources, comprising:
identifying a first metadata set associated with data resources;
accessing a metadata store;
determining the metadata set used to index data in the metadata store;
identifying an appropriate resource description framework transcoder to translate information stored in the metadata set used to index data such that the information is compatible with the first metadata set; and
executing the appropriate resource description framework transcoder.

16. The method of claim 15, wherein identifying a first metadata set associated with data resources comprises data resources selected from the group consisting of video information, audio information, audio-visual information, dynamic documents, and slide presentations.

17. The method of claim 15, wherein identifying a first metadata set associated with data resources comprises a metadata set compatible with a client application.

18. The method of claim 17, further comprising:
providing the translated information to the client application; and
using the client application to access data resources.

19. A method for exposing data resources, comprising:
receiving a data access request including information indicating a data type of interest and a first metadata set;
identifying an accessible data resource of the same data type;
determining a metadata set used when the accessible data resource was integrated in a data store;
selecting a suitably configured transcoder to translate stored metadata into data compatible with the first metadata set;
executing the transcoder; and
forwarding translated metadata responsive to information in the data access 11 request.

20. The method of claim 19, wherein receiving a data access request comprises receiving information identifying a client application.

21. The method of claim 19, wherein receiving a data access request comprises receiving information a data type selected from the group consisting of video information, audio information, audio-visual information, dynamic documents, and slide presentations.

22. The method of claim 19, further comprising:
responding to consumer requests for accessible data resources.
